(19) United States
(12) Patent Application Publication
(10) Pub. No.: US 2024/0160679 A1
(43) Pub. Date: May 16, 2024

(54) SYSTEMS, METHODS AND COMPUTER READABLE MEDIA FOR SERVICE PROVIDER MATCHING USING REVIEWS

(71) Applicants: Joseph Anthony Pilliterri, Colorado Springs, CO (US); Ginger Diane Pilliterri, Colorado Springs, CO (US)

(72) Inventors: Joseph Anthony Pilliterri, Colorado Springs, CO (US); Ginger Diane Pilliterri, Colorado Springs, CO (US)

(21) Appl. No.: 18/197,713

(22) Filed: May 15, 2023

Related U.S. Application Data
(63) Continuation-in-part of application No. 18/092,441, filed on Jan. 2, 2023.
Application No. 18/092,441 is a continuation-in-part of application No. 17/163,075, filed on Jan. 29, 2021, now Pat. No. 11,544,337.
(60) Provisional application No. 62/968,868, filed on Jan. 31, 2020.

(51) Int. Cl. G06F 16/9535; G06Q 30/0204; G06Q 30/0282

(52) U.S. Cl. CPC G06F 16/9535; G06Q 30/0205; G06Q 30/0282

(57) ABSTRACT

Some implementations can include a computer-implemented method, computer readable media and/or system for providing search results or recommendations based on reviews by users matching one or more traits of a searching user.

### RELATED APPLICATIONS

This application is a continuation in part of U.S. application Ser. No. 18/092,441, entitled “Systems, Methods And Computer Readable Media For Special Needs Service Provider Matching And Reviews,” filed on Jan. 2, 2023, which is a continuation in part of U.S. application Ser. No. 17/163,075, entitled “System to Match Special Needs Service Providers with Recipients,” filed on Jan. 29, 2021, now U.S. Pat. No. 11,544,337 issued on Jan. 3, 2023, which claims priority to U.S. Provisional Application No. 62/968,868, entitled “Systems, Method and Computer Readable Media for Special Needs Service Provider Matching,” and filed on Jan. 31, 2020, each of which is incorporated herein by reference in its entirety.

### FIELD

Some implementations relate to the field of computer databases. More specifically, some implementations relate to a system configured to match a combination of user query data with stored review data corresponding to service providers in a specialized database where information about a reviewer is matched with information about a user associated with a query.

### BACKGROUND

When people are searching for a product, service, destination, experience, or the like online, reviews are often presented. However, the reviews are typically general in nature and may have been provided by users who may not have much in common with a user who is searching. A need may exist to improve search results by providing results that have associated reviews provided by users that have something in common or similar likes concerning the search query with the user doing the searching. Some implementations were conceived in light of the above-mentioned problems and limitations, among other things. For example, a person is reading reviews for a steakhouse in their area and comes across search results. The results are from others that have rated the steakhouses, but these results do not tell the searcher whether the search can trust the results without revealing what else that person likes so that the searcher can determine whether the search and the reviewer share similar tastes. Another example is searching for a movie and the results indicate that a particular movie has received a high rating. However, the question is what other movies do the reviewers like. If the searcher can trust the tastes of the person giving the review, they are more likely to trust the review itself.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

Some implementations can include a method comprising obtaining user registration data, obtaining service provider registration data, and receiving a query. The method can also include matching a combination of query data and user registration data with the service provider registration data, and reviewing user registration data, and outputting a result of the matching, wherein the result includes one or more records including one or more service providers and corresponding reviews or ratings that match within a given threshold.

The method can further include filtering the result of the matching based on one or more third-party data items and outputting the filtered results. In some implementations, the diagnosis or the condition is independent of a service provided by the service provider, and wherein the matching results include service provider data indicating that the matching service providers provide the service from the query to people having the diagnosis or the condition. In some implementations, the third-party data includes one of a rating above a rating threshold or a verification, wherein the rating threshold is included as part of the query, and the verification indicates that the service provider was verified by a third-party. In some implementations, another option can include that the searcher can add that particular person given the higher probability of trusted reviews to a “trusted source” to be able to see more of their reviews.

### BRIEF DESCRIPTION OF THE DRAWINGS

FIG. 1 is a block diagram of an example service provider matching system in accordance with some implementations.

FIG. 2 is a flowchart of an example method of service provider matching in accordance with some implementations.

FIG. 3 is a block diagram of an example computing device in accordance with some implementations.

FIG. 4 is a diagram of an example review matching in accordance with some implementations.

### DETAILED DESCRIPTION

The systems and methods provided herein may overcome one or more deficiencies of some conventional methods of providing search results to users.

Some implementations can include a method or system to search for services using a combination of searching user data and reviewing user data. Some implementations can include searching using a current location or a selected location (e.g., for vacation, relocation research, etc.). Some implementations can include presenting a semi-personalized view of a website (or section of website, e.g., a “Selected for You” type section) for each visitor, where view is based on location, one or more diagnoses, age, history of use, etc. Some implementations can include alerts to members about new matching reviews.

For example, a user can enter information (e.g., likes, dislikes, etc.) that can be used to initial help provide improved search results to the user. In some instances, a user's actions (e.g., search or rating history) can also be used as data to provide initial search results. Then, the system can monitor and learn a user's preferences and adapt over time (e.g., via a machine learning model) to improve the accuracy of the search results provided to the user. The learning can be accomplished by feeding back a user's searches, selections, and reviews/ratings back into the system for service provider matching using reviews. For example, initially the system may identify a search result of a restaurant having a 4.3-star review average as being 30% likely to match a given user's preferences and over time as the system adapts, the likelihood may be updated to 80% based on the system monitoring and learning that user's preferences. Accordingly, the restaurant may move up higher in sorted results provided to that user based on the improved likelihood related to that specific user.

Some implementations can include a website, a mobile application, and/or a desktop application. Some implementations can be configured for use with voice activated devices (Alexa, Siri, Google Home, or other smart speaker, etc.), a virtual assistant or any other voice queries and a natural-language user interface to answer questions, make recommendations, and perform actions by delegating requests to a set of Internet services in order to use the information to make recommendations for a user. Artificial intelligence (AI) compatible to learn the functionality, ability, limitations, etc. of a user and make recommendations on maps or other means for services, parks, tools, toys, nutrition, diet, or other recommendations. For example, if the system has permission to monitor conversations, the system could monitor parents talking about a diagnosis or condition of themselves of a family member. The system can use what info was gathered and use the rating system to automatically recommend a professional car a course of action, a forum, blog, or a discussion group on the website, etc. that has been matched according to the technique described herein using a machine learning model.

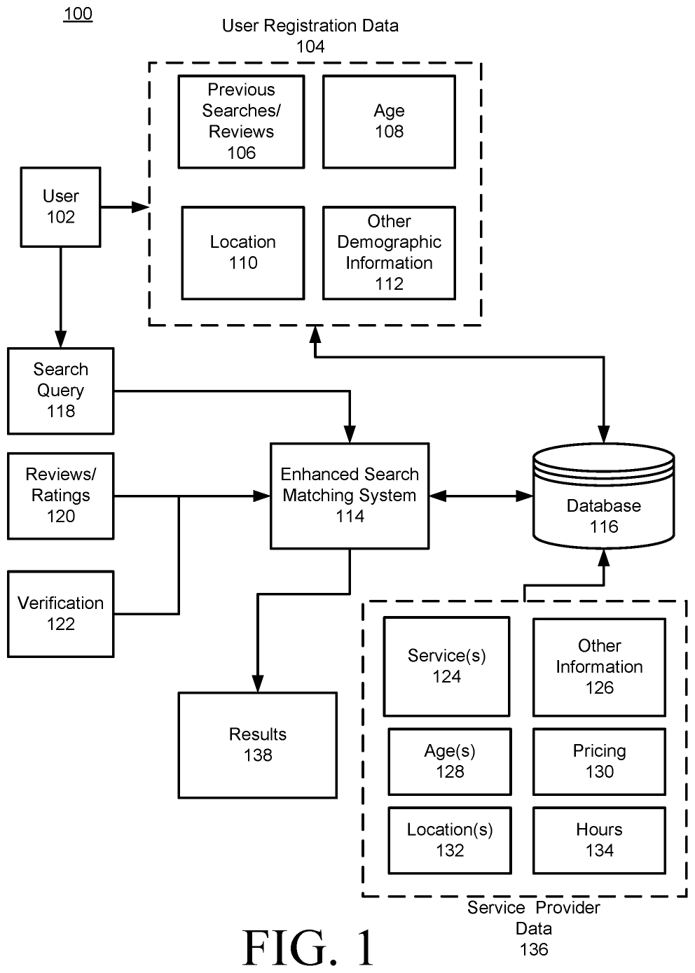

FIG. 1 is a block diagram of an example service provider matching system environment 100 in accordance with some implementations. The system environment 100 can include one or more users 102, where each user provides user registration data 104 that can include previous searches or reviews 106, an age 108, a location 110, and/or other demographic information 112. The user registration data 104 can be stored in a data store or database 116 via an enhanced search matching system 114.

The enhanced search matching system 114 can access the database 116 to store service provider registration data 136, which can include services provided 124, other information 126, ages 128, pricing 130, location(s) 132, or hours 134.

The enhanced search matching system 114 also receives a search query 118 from the user 102. The search query can include a service that the user is searching for (e.g., haircut or music lesson). The enhanced search matching system 114 also receives reviews/ratings 120 of service providers and verifications 122 of service providers.

The enhanced search matching system 114 matches service providers with user queries based on the method described below to generate results 138. In some implementations, the results can include a match value such as a percentage match and/or a points or star system value that indicates how closely a service provider matches the search query for a given person. The matching service providers can be sorted by the match value for display to a user.

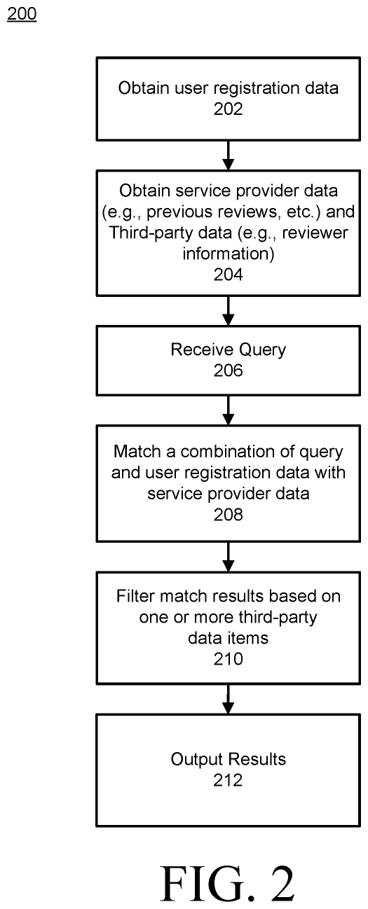

FIG. 2 is a flowchart for service provider matching in accordance with some implementations. Processing begins at 202, where user registration data is received. Processing continues to 204.

At 204, service provider registration data is received. Processing continues to 206.

At 206, a query is received. Processing continues to 208.

At 208, a combination of query and user registration data is matched against service provider registration data. For example, if a user query is haircut, the system will match against a service provider (barber or hairdresser). The match may be exact or may be within a threshold or a nearest match. Processing continues to 210.

At 210, results from 208 are optionally filtered based on one or more third-party data items such as rating or verification. For example, a person may want a service provider with a rating above a given threshold and that has been verified. Processing continues to 212.

At 212, the results (e.g., the match results or the filtered match results) are output. The output can include an electronic message transmitted to a mobile device, an email sent automatically from the system to an email account, a synthesized voice call, audio output from a device, a printed output, or an electronic message transmitted to another system, or a display of the output information on a display device.

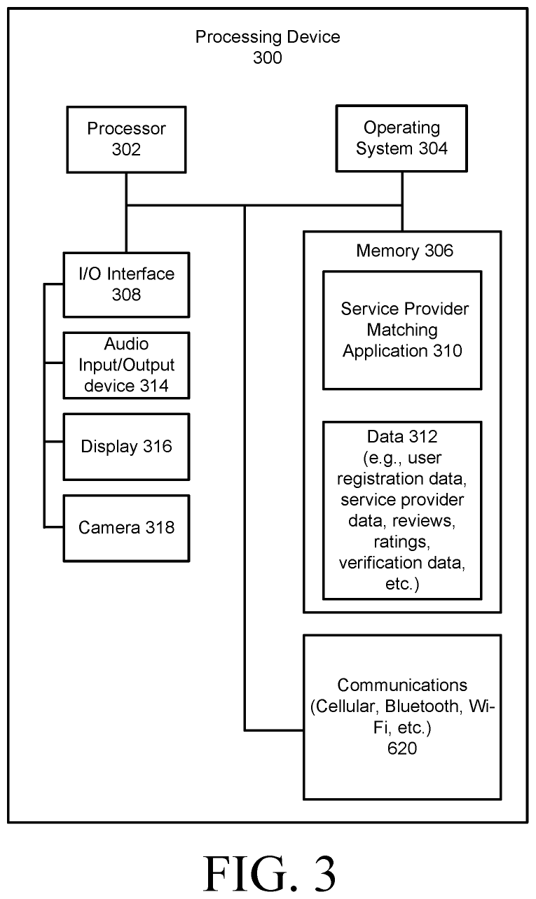

FIG. 3 is a block diagram of an example processing device 300 which may be used to implement one or more features described herein. In one example, device 300 may be used to implement a computer device, e.g., a server device (e.g., 114 of FIG. 1), and perform appropriate method implementations described herein (e.g., one or more of 202-210). Device 300 can be any suitable computer system, server, or other electronic or hardware device. For example, the device 300 can be a mainframe computer, desktop computer, workstation, portable computer, laptop computer, or electronic device (portable device, mobile device, cell phone, smart phone, tablet computer, television, TV set top box, personal digital assistant (PDA), media player, game device, wearable device, etc.). In some implementations, device 300 includes a processor 302, an operating system 304, a memory 306, and input/output (I/O) interface 308.

Processor 302 can be one or more processors and/or processing circuits to execute program code and control basic operations of the device 300. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. Processing need not be limited to a particular geographic location or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 306 is typically provided in device 300 for access by the processor 302 and may be any suitable processor-readable storage medium, e.g., random access memory (RAM), read-only memory (ROM), Electrical Erasable Read-only Memory (EEPROM), Flash memory, etc., suitable for storing instructions for execution by the processor, and located separate from processor 302 and/or integrated therewith. Memory 306 can store software operating on the server device 300 by the processor 302, including an operating system 304, one or more applications 310, and data 312. In some implementations, applications 310 can include instructions that enable processor 302 to perform the functions described herein, e.g., some or all of the methods of FIG. 2.

For example, applications 310 can include a service provider matching application. Other applications or engines 314 can also or alternatively be included in applications 310, e.g., email applications, SMS and other phone communication applications, web browser applications, media display applications, communication applications, web hosting engine or application, social networking engine or application, etc. Any software in memory 304 can alternatively be stored on any other suitable storage location or computer-readable medium. In addition, memory 304 (and/or other connected storage device(s)) can store images, video, and other instructions and data used in the features described herein. Memory 304 and any other type of storage (magnetic disk, optical disk, magnetic tape, or other tangible media) can be considered “storage” or “storage devices.”

I/O interface 308 can provide functions to enable interfacing the server device 300 with other systems and devices. For example, network communication devices, storage devices (e.g., memory and/or database), and input/output devices can communicate via interface 308. In some implementations, the I/O interface 308 can connect to interface devices including input devices (keyboard, pointing device, touchscreen, microphone, camera, scanner, etc.) and/or output devices (display device, speaker devices, printer, motor, etc.). Audio input/output device 314 (e.g., microphone and speaker), display device 316 and camera device 318 are examples of input/output devices that may be used to capture input (microphone and/or camera) and to provide output (display and speaker). Display device 316 can be connected to device 300 via local connections (e.g., display bus) and/or via networked connections and can be any suitable display device, some examples of which are described below.

For ease of illustration, FIG. 3 shows one block for each of processor 302, memory 306, I/O interface 308, and software block 310. These blocks may represent one or more processors or processing circuitries, operating systems, memories, I/O interfaces, applications, and/or software modules. In other implementations, device 300 may not have all of the components shown and/or may have other elements including other types of elements instead of, or in addition to, those shown herein. While 114 is described as performing operations as described in some implementations herein, any suitable component or combination of components of system 114 or similar system, or any suitable processor or processors associated with such a system, may perform the operations described.

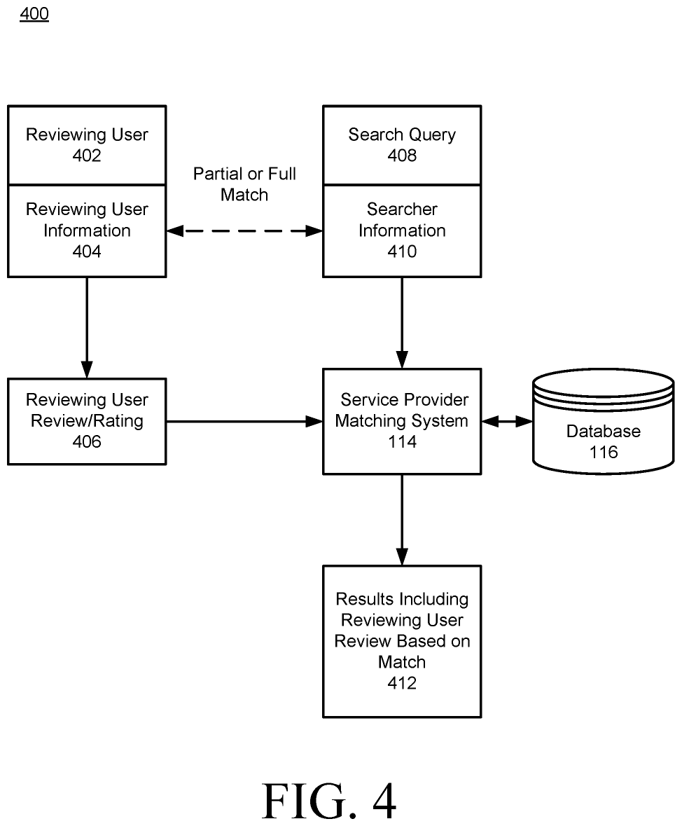

FIG. 4 is a diagram of an example review matching 400 in accordance with some implementations. A reviewing user 402 associated with reviewing user information 404 provides a review and/or rating 406. The information can include reviewing user registration data or other information provided as part of a registration process or via another method. The registration data can be data that is provided as part of a user registration process or data that is provided temporarily for the purpose of searching or reviewing. The review/rating 406 can include a numeric or other rating (e.g., star rating or percentage rating) of one or more factors or aspects of a service provider. The review/rating can also include one or more of a written review, one or more pictures, one or more videos, one or more audio files, or any other suitable information for a review. Registration data as used herein, whether for a searching user or a reviewing user, can include information entered by the user (e.g., demographic information, like/dislikes, etc.), information automatically gleaned from a user's history (e.g., search history, review history, purchase history, etc.), or obtained in other ways.

As used herein, a service provider can include any of the service provider types mentioned above and can also include more general service providers such as parks, playgrounds, entertainment venues, educational venues, cultural venues, restaurants, sports venues, businesses, organizations, state parks, national parks, city parks, lodging, activities, shopping venues, or the like. In general, any activities that people can engage in can be considered service providers for the review matching process described herein. Some implementations can include reviews or ratings for products as well as services or service providers.

The reviewing user review/rating 406 is provided to the enhanced search matching system 114 and stored in database 116. A search query 408 and corresponding information 410 is received at the enhanced search matching system 114.

The search query 408 can include a search query from a user seeking a service provider. The search query can also include a search query generated by a third-party system on behalf of a human user or generated automatically by the third-party system. For example, a user searching a traditional search site such as a search engine or a review/ratings website may enter a search query. Initial searching or matching can be performed by the search engine or other site (e.g., ratings and reviews, etc.) according to conventional search techniques or later developed search techniques. Query matching can include providing results based on relevance or another factor by the search engine or review/ratings website.

A third-party system may detect the search intent and gather additional search criteria (e.g., age, other demographics, etc.). In general, any kind of system (e.g., audio monitoring, communications monitoring, video monitoring, etc.) that can detect or infer a user's needs, whether expressed or otherwise, can be used to determine interest, search intent, desire or requirement. Alternatively, or in addition to the third-party system, the service provider matching system may gather the information 410 from the searching user or system via a user interface or programmatic interface (e.g., an API) that permits the enhanced search matching system 114 to interact with the searching user or system. Search query 408 and the additional information 410 are provided to the enhanced search matching system 114.

The service provider matching system (e.g., via the matching module) determines that there is a partial or full match between the information of the reviewer 404 and the search query information 410. Based on this matching, the enhanced search matching system 114 can provide review/rating results 412 in response to the search query that include the reviewing user review/rating 406. The reviewing user review/rating 406 can be provided to the searching user via the third-party system or directly. Further, a user may be searching or otherwise expressing interest in a service provider in one format (e.g., a search engine) and the review/rating or other recommendation information can be provided in a different format or via a different platform (e.g., via online advertising in a social media platform or other system). By providing reviews/ratings that are matched based on searching user/reviewer information, the searching user can have a higher confidence that the reviews are relevant to both the service provider or service type being searched and the information. This can produce higher user confidence and potentially higher user satisfaction in the search results 412. For example, a user may be searching for a steakhouse. Matching results (e.g., say steakhouses in the area of the user) can include a steakhouse with a rating of 4.8 out of 5 stars and one with 4.3 out of five stars. However, here is 4.8 stars, but based on user preferences and preferences of similar users there is only about 80% probability you will like this restaurant. Typically, a user may choose the steakhouse with a 4.8-star rating based simply on that rating. However, in conventional search systems or review systems, there may be no correlation between the searching user and the users that provided the reviews leading to the 4.8-star rating. With an implementation of the disclosed subject matter, the enhanced matching based on searching user and reviewer information could determine that based on the reviewer information and the search information, the steakhouse with a 4.3-star rating may have a probability of 95% that the searching user will like it, whereas the steakhouse with the 4.8 star rating may only have a probability of 80% that the searching user will like it. The confidence predictions could be based on generating a personalized rating value that includes those reviews provided by reviewers that match the searcher. In other words, the system could determine a customized rating or match confidence value based on a comparison of the searching user information and the reviewing users' information.

Some implementations can provide reasoning for confidence difference (e.g., searching user is more interested in food than atmosphere and this could be a determining factor in the steakhouse matching example and be provided to the searching user as a rationale or reason for the recommendation). Further, in some implementations, the system can be configured to provide feedback to service providers such as the characteristics of reviewers that are most satisfied with their service, which could be used for marketing or advertising, and information about what aspects contribute to the positive ratings or reviews and what aspects may be improved upon.

The matching provided by the service provider matching system can be provided as an augmented service that can be overlaid on a traditional search website such as a search engine, reviews site, directory website, or other type of website. In general, the service provider and review matching can be used to provide more tailored and relevant search results to those users seeking information more relevant to the searching user.

Some implementations can be used for any kind of directory such as recreation, or any aspect of normal life.

In general, some implementations can include matching a type of person giving reviews with a type of person receiving to generate a review confidence score and provide reviews that may be more relevant to the review receiver.

One or more methods described herein (e.g., methods 200 or 400) can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g., Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating system.

One or more methods described herein can be run in a standalone program that can be run on any type of computing device, a program run on a web browser, a mobile application (“app”) run on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

The enhanced search matching system 114 can include one or more machine learning models such as a neural network. The training of the model can include user-specific training of the neural network(s) based on past user service provider choices, etc. The training approach mentioned above could include associated weights for predictions. In some implementations, the trained model is trained offline and/or online, e.g., if the user selects a service provider that was predicted, that can act as positive reinforcement to the model, while if the user chooses a different service provider that can serve as negative reinforcement. Online training can permit the machine learning model to dynamically adjust predictions of service providers or service provider recommendations. Online training permits the system to adjust the selection process over time.

In some implementations, a single neural network can be trained based on data with weights assigned to training inputs.

The model form or structure may specify connectivity between various nodes and organization of nodes into layers. For example, nodes of a first layer (e.g., input layer) may receive data as input data or application data. Subsequent intermediate layers may receive as input output of nodes of a previous layer per the connectivity specified in the model form or structure. These layers may also be referred to as hidden layers. A final layer (e.g., output layer) produces an output of the machine-learning application. For example, the output may provide one or more service provider recommendations or suggestions.

In some implementations, the trained model may include weighted individual nodes and/or connections. A respective weight may be applied to a connection between each pair of nodes that are connected per the model form, e.g., nodes in successive layers of the neural network. In some implementations, respective weights may be randomly assigned, or initialized to default values. The model may then be trained, e.g., using data, to produce a result, where the training can include adjusting one or more of nodes, node structure, connections, and/or weights.

A model can include a loss function representing the difference between a predicted value and an actual label. The model can be trained to minimize the loss function. Training can include supervised, unsupervised, or semi-supervised learning techniques. In supervised learning, the training data can include a plurality of inputs and a corresponding expected output for each input. Based on a comparison of the output of the model with the expected output (e.g., computing the loss function), values of the weights are automatically adjusted, e.g., in a manner that increases a probability that the model produces the expected output when provided similar input (i.e., reduces the loss function). In unsupervised learning, models learn relationships between elements in a data set and classify raw data without the benefit of labeled training data. Semi-supervised learning can include a combination of supervised and unsupervised techniques, for example, a small amount of labeled training data and a large amount of unlabeled training data can be provided to a model for learning. Once the model is trained, it can be used to predict service providers based on real-world data.

In some implementations, neural networks (as well as other learning algorithms) tend to produce a weighted set of choices. Some implementations can include performing the training step until the weight for the correct answer is a threshold value larger than the next option. By continually improving the data set, and by discarding incorrect decisions, there may be little downside to shipping any particular network. Performance can be analyzed by tracking how well any particular network is performing over time.

Although the description has been described with respect to particular implementations thereof, these particular implementations are merely illustrative, and not restrictive. Concepts illustrated in the examples may be applied to other examples and implementations.

Note that the functional blocks, operations, features, methods, devices, and systems described in the present disclosure may be integrated or divided into different combinations of systems, devices, and functional blocks as would be known to those skilled in the art. Any suitable programming language and programming techniques may be used to implement the routines of particular implementations. Different programming techniques may be employed, e.g., procedural or object-oriented. The routines may execute on a single processing device or multiple processors. Although the steps, operations, or computations may be presented in a specific order, the order may be changed in different particular implementations. In some implementations, multiple steps or operations shown as sequential in this specification may be performed at the same time.

It will be appreciated that the modules, processes, systems, and sections described above can be implemented in hardware, hardware programmed by software, software instructions stored on a nontransitory computer readable medium or a combination of the above. A system as described above, for example, can include a processor configured to execute a sequence of programmed instructions stored on a nontransitory computer readable medium. For example, the processor can include, but not be limited to, a personal computer or workstation or other such computing system that includes a processor, microprocessor, microcontroller device, or is comprised of control logic including integrated circuits such as, for example, an Application Specific Integrated Circuit (ASIC). The instructions can be compiled from source code instructions provided in accordance with a programming language such as Java, C, C++, C #.net, assembly or the like. The instructions can also comprise code and data objects provided in accordance with, for example, the Visual Basic™ language, or another structured or object-oriented programming language. The sequence of programmed instructions, or programmable logic device configuration software, and data associated therewith can be stored in a nontransitory computer-readable medium such as a computer memory or storage device which may be any suitable memory apparatus, such as, but not limited to ROM, PROM, EEPROM, RAM, flash memory, disk drive and the like.

Furthermore, the modules, processes systems, and sections can be implemented as a single processor or as a distributed processor. Further, it should be appreciated that the steps mentioned above may be performed on a single or distributed processor (single and/or multi-core, or cloud computing system). Also, the processes, system components, modules, and sub-modules described in the various figures of and for embodiments above may be distributed across multiple computers or systems or may be co-located in a single processor or system. Example structural embodiment alternatives suitable for implementing the modules, sections, systems, means, or processes described herein are provided below.

The modules, processors or systems described above can be implemented as a programmed general purpose computer, an electronic device programmed with microcode, a hard-wired analog logic circuit, software stored on a computer-readable medium or signal, an optical computing device, a networked system of electronic and/or optical devices, a special purpose computing device, an integrated circuit device, a semiconductor chip, and/or a software module or object stored on a computer-readable medium or signal, for example.

Embodiments of the method and system (or their sub-components or modules) may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a PLD, PLA, FPGA, PAL, or the like. In general, any processor capable of implementing the functions or steps described herein can be used to implement embodiments of the method, system, or a computer program product (software program stored on a nontransitory computer readable medium).

Furthermore, embodiments of the disclosed method, system, and computer program product (or software instructions stored on a nontransitory computer readable medium) may be readily implemented, fully or partially, in software using, for example, object or object-oriented software development environments that provide portable source code that can be used on a variety of computer platforms. Alternatively, embodiments of the disclosed method, system, and computer program product can be implemented partially or fully in hardware using, for example, standard logic circuits or a VLSI design. Other hardware or software can be used to implement embodiments depending on the speed and/or efficiency requirements of the systems, the particular function, and/or particular software or hardware system, microprocessor, or microcomputer being utilized. Embodiments of the method, system, and computer program product can be implemented in hardware and/or software using any known or later developed systems or structures, devices and/or software by those of ordinary skill in the applicable art from the function description provided herein and with a general basic knowledge of the software engineering, image processing and/or machine vision arts.

Moreover, embodiments of the disclosed method, system, and computer readable media (or computer program product) can be implemented in software executed on a programmed general-purpose computer, a special purpose computer, a microprocessor, a network server or switch, or the like.

It is, therefore, apparent that there is provided, in accordance with the various embodiments disclosed herein, methods, systems and computer readable media for service provider matching.

While the disclosed subject matter has been described in conjunction with a number of embodiments, it is evident that many alternatives, modifications and variations would be, or are, apparent to those of ordinary skill in the applicable arts. Accordingly, Applicants intend to embrace all such alternatives, modifications, equivalents and variations that are within the spirit and scope of the disclosed subject matter.

What is claimed is:

1. A system to provide enhanced search results including service providers and reviews based on matching a first user to one or more other users over a communications network, the system comprising:
at least one computer terminal associated with the first user for allowing the first user to access the communications network;
a network server coupled to the communications network, the network server comprising a computer program having:
a service provider database, wherein the service provider database comprises information related to one or more of a plurality of service providers, services offered, ages, pricing, locations, or hours of each of the plurality of service providers, and wherein the service provider database comprises one or more service provider reviews each associated with a specific service provider and a reviewing user that created a given review;
a user registration database to store user registration data, wherein the user registration data includes information about the first user and the reviewing user;
a processor configured to:
receive a user query including a combination of the user query and the user registration data;
automatically determine, via a matching module, an output including one or more matching service providers; and
permit the user to select a matching service provider from among the one or more matching service providers from a graphical user interface to perform one of obtaining additional information about the selected matching service provider or contacting the selected matching service provider.

2. The system of claim 1, wherein the output is based in part on a subject of mutual interest to the first user and the reviewing user.

3. The system of claim 1, wherein the output includes service provider data indicating that the one or more matching service providers provide a queried service that is included as part of the user query.

4. The system of claim 3, further comprising filtering the output based on one or more third-party data items and outputting the filtered output.

5. The system of claim 4, wherein the one or more third-party data items includes one or more of a rating above a rating threshold or a verification status, wherein the rating threshold is included as part of the user query, and the verification status indicates that the matching service provider is verified by a third-party.

6. The system of claim 4, wherein the filtered output includes one or more of an electronic message transmitted to a mobile device, an email sent automatically to an email account, a synthesized voice call, audio output from a device, a printed output, or an electronic message transmitted to another system, or a display on a display device.

7. A non-transitory computer-readable storage medium containing software instructions to operate a system to match a user to a service provider over a communications network, the system comprising:
at least one computer terminal associated with the user for allowing the user to access the communications network;
a network server coupled to the communications network, the network server comprising a computer program having:
a service provider database, wherein the service provider database comprises information related to one or more of a plurality of service providers, services offered, ages, pricing, locations, or hours of each of the plurality of service providers;
a user registration database to store user registration data, wherein the user registration data includes information about the first user and the reviewing user;
the software instructions including a first software portion that when executed by one or more processors cause the one or more processors to perform operations including:
receiving a user query, wherein a combination of the user query and the user registration data in the user registrations database is used as an input to a matching module;
automatically determining, via the matching module, an output including one or more matching service providers;
the software instructions including a second software portion that when executed by one or more processors cause the one or more processors to perform operations including:
permitting the user to select a matching service provider from among the one or more matching service providers from a graphical user interface; and
scheduling a service session for the user with the selected matching service provider via the graphical user interface.

8. The non-transitory computer-readable storage medium of claim 7, wherein the output is based in part on a subject of mutual interest to the first user and the reviewing user.

9. The non-transitory computer-readable storage medium of claim 7, wherein the output includes service provider data indicating that the one or more matching service providers provide a queried service that is included as part of the user query.

10. The non-transitory computer-readable storage medium of claim 9, further comprising filtering the output based on one or more third-party data items and outputting the filtered output.

11. The non-transitory computer-readable storage medium of claim 10, wherein the one or more third-party data items includes one or more of a rating above a rating threshold or a verification status, wherein the rating threshold is included as part of the user query, and the verification status indicates that the matching service provider is verified by a third-party.

12. The non-transitory computer-readable storage medium of claim 10, wherein the filtered output includes one or more of an electronic message transmitted to a mobile device, an email sent automatically to an email account, a synthesized voice call, audio output from a device, a printed output, or an electronic message transmitted to another system, or a display on a display device.

13. A computer implemented method to match a user to a service provider over a communication network, the method comprising:
obtaining user registration data from a first user;
obtaining reviewing user registration data from a reviewing user;
obtaining service provider registration data, wherein the service provider registration data includes information related to a plurality of services offered, ages serviced, pricing, locations, or hours of a plurality of service providers;
receiving a user query including a combination of the user query and the user registration data;
matching the combination of the user query and the user registration data with the service provider registration data to generate initial search results;
automatically determining, via the matching module, a sorted output based on the initial search results and associated reviews or ratings for the one or more matching service providers in the initial search results, wherein the associated reviews or ratings include a review or rating from the reviewing user based on a match between at least a portion of the reviewing user registration data and the user registration data, and wherein the sorted output is ordered according to similarity between a searching user and one or more reviewing users associated with the corresponding reviews or and ratings for the one or more matching service providers; and
outputting the sorted output, wherein the sorted output includes one or more records that match within a given threshold, and wherein the result includes one or more matching service providers and associated reviews or ratings.

14. The method of claim 13, wherein the sorted output is based in part on a subject of mutual interest to the first user and the reviewing user.

15. The method of claim 13, wherein the sorted output includes service provider data indicating that the one or more matching service providers provide a queried service that is included as part of the user query.

16. The method of claim 15, further comprising filtering the result of the matching based on one or more third-party data items and outputting the filtered result of the matching.

17. The method of claim 16, wherein the one or more third-party data items includes one or more of a rating above a rating threshold or a verification status, wherein the rating threshold is included as part of the user query, and the verification status indicates that the matching service provider is verified by a third-party.

18. The method of claim 16, wherein the filtered output includes one or more of an electronic message transmitted to a mobile device, an email sent automatically to an email account, a synthesized voice call, audio output from a device, a printed output, or an electronic message transmitted to another system, or a display on a display device.
